(19) United States
(12) Patent Application Publication
(10) Pub. No.: US 2024/0376682 A1
(43) Pub. Date: Nov. 14, 2024

(54) STREET CABINET ARRANGEMENT HAVING A BASE PORTION CONFIGURED TO BE DISPOSED UNDERGROUND BENEATH A FOOTPATH AND TO PROVIDE SUPPORT FOR A BOX PORTION TO BE DISPOSED OUTSIDE OF THE FOOTPATH SO AS TO PROVIDE ENHANCED ACCESS TO CONTENTS OF THE BOX PORTION WITHOUT OBSTRUCTING THE FOOTPATH

(71) Applicant: PPC BROADBAND, INC., East Syracuse, NY (US)

(72) Inventors: Peter BITTMANN, Berlin (DE); Andreas LEYER, Potsdam (DE)

(73) Assignee: PPC BROADBAND, INC., East Syracuse, NY (US)

(21) Appl. No.: 18/662,729

(22) Filed: May 13, 2024

(30) Foreign Application Priority Data
May 12, 2023 (DE) 102023112638.5

(51) Int. Cl. E02D 29/14; H02G 9/10

(52) U.S. Cl. CPC E02D 29/1454; H02G 9/10

(57) ABSTRACT

A street cabinet arrangement may include a box portion configured to house contents of a communications network therein and a base portion configured to be disposed underground and having a portion that is configured to support the box portion. The base portion may include a projection base portion configured to extend from the main base portion. At least a portion of the main base portion may be configured to be disposed underground beneath a footpath with a longitudinal dimension of the main base portion and a longitudinal dimension of the projection base portion extending parallel to one another and to the footpath such that at least a portion of the projection base portion is disposed outside of the footpath and configured to support the box portion outside of the footpath with an access portion of the box portion configured to extend parallel to the footpath and facing the footpath so as to provide enhanced access to contents of the box portion from the footpath without obstructing the footpath with the box portion.

### CROSS-REFERENCE TO RELATED APPLICATION

This application claims the benefit of German Patent Application No. 10 2023 112 638.5, filed May 12, 2023, the contents of which are incorporated herein by reference.

### TECHNICAL FIELD

The present disclosure relates to a street cabinet arrangement and, more particularly, to a street cabinet arrangement having a base portion configured to be disposed underground beneath a footpath and to provide support for a box portion to be disposed outside of the footpath so as to provide enhanced access to contents of the box portion without obstructing the footpath.

### BACKGROUND

Such devices are often referred to as underground shafts or ground shafts. Typically, such devices have a cuboid interior and a cover. Such devices are often arranged in the area of footpaths or streets. Branching elements or connecting elements of supply networks are often arranged in the interior spaces of the devices. For example, these can be components of a communications network or an energy supply network.

In some conventional ground shafts, both the side walls and the cover of such devices are made of concrete. However, some conventional ground shafts are made of plastic. For example, some conventional ground shafts include side walls comprising individual plastic modules that are configured to be connected to one another. Such devices are described, for example, in WO 2017/025077 A1, DE 10 2010 050 964 B3, and DE 10 2012 101 366 B3, the contents of which are incorporated herein by reference.

In the case of a combination of shaft modules with box modules, it has not yet been possible to meet all the requirements for sufficient adaptability to specifically specified application requirements. In particular, both the number and the volume and the geometric shape of the components used often vary. The devices are often arranged in the area of sidewalks or footpaths or other paved areas. When arranged in the area of footpaths, the covers of the shaft modules are often arranged in such a way that the covers extend with their longitudinal axes in the direction of a longitudinal axis of the shaft module and in a longitudinal direction of the footpath. If a relatively large shaft module with several covers is required, the arrangement is typically such that the corresponding extension is implemented starting from the box module and into the footpath.

Accordingly, it may be desirable to provide a street cabinet arrangement having a base portion configured to be disposed underground beneath a footpath and to provide support for a box portion to be disposed outside of the footpath so as to provide enhanced access to contents of the box portion from the footpath without obstructing the footpath with the box portion.

### SUMMARY

According to an exemplary embodiment of the disclosure, a street cabinet arrangement may include a box portion configured to house contents of a communications network therein and having an access portion configured to provide access to the contents along a longitudinal surface portion of the box portion, and a base portion configured to be disposed underground and having a portion that is configured to support the box portion, The base portion may include a main base portion having spaced apart longitudinal wall portions connected with spaced apart lateral wall portions that extend in a transverse direction and a projection base portion configured to extend from a first one of the longitudinal wall portions of the main base portion. The projection base portion may include a longitudinal wall portion configured to extend parallel to the longitudinal wall portions of the main base portion and spaced apart lateral walls configured to extend in the transverse direction from the first one of the longitudinal wall portions of the main base portion to the longitudinal wall portion of the projection base portion. The longitudinal wall portions and lateral wall portions of the main base portion and the longitudinal wall portion and the lateral wall portions of the projection base portion may comprise modular elements that are configured to be coupled with one another to form a continuous frame portion, and the frame portion may be configured to be stacked with another frame portion to form the base portion. The main base portion may have a longitudinal dimension and a transverse dimension, and the longitudinal dimension is greater than the transverse dimension, the projection base portion may have a longitudinal dimension and a transverse dimension, and the longitudinal dimension of the projection base portion may be greater than the transverse dimension of the projection base portion, and an interior space of the main base portion may be open to an interior space of the protection base portion so as maximize a continuous interior space of the base portion and enhance a path for cabling to run from the base portion to the box portion. At least a portion of the main base portion is may be configured to be disposed underground beneath a footpath with the longitudinal dimension of the main base portion and the longitudinal dimension of the projection base portion extending parallel to one another and to the footpath such that at least a portion of the projection base portion is disposed outside of the footpath and configured to support the box portion outside of the footpath with the longitudinal surface portion of the box portion configured to extend parallel to the footpath and the access portion facing the footpath so as to provide enhanced access to contents of the box portion from the footpath without obstructing the footpath with the box portion.

In some aspects, the foregoing arrangement may further include a cover portion configured to cover a top portion of the main base portion.

In some embodiments of the foregoing arrangements, the main base portion and the projection base portion may each have a substantially rectangular cross-sectional area in a horizontal direction.

In some embodiments of the foregoing arrangements, at least a portion of the frame portion may comprise plastic.

In some embodiments of the foregoing arrangements, the box portion may comprise a cabinet, and the access portion may comprise a door.

According to an exemplary embodiment of the disclosure, a street cabinet arrangement may include a box portion configured to house contents of a communications network therein and a base portion configured to be disposed underground and having a portion that is configured to support the box portion. The base portion may include a main base portion having spaced apart longitudinal wall portions connected with spaced apart lateral wall portions that extend in a transverse direction, and the base portion may include a projection base portion configured to extend from a first one of the longitudinal wall portions of the main base portion. The projection base portion may include a longitudinal wall portion configured to extend parallel to the longitudinal wall portions of the main base portion and spaced apart lateral walls configured to extend in the transverse direction from the first one of the longitudinal wall portions of the main base portion to the longitudinal wall portion of the projection base portion. At least a portion of the main base portion may be configured to be disposed underground beneath a footpath with a longitudinal dimension of the main base portion and a longitudinal dimension of the projection base portion extending parallel to one another and to the footpath such that at least a portion of the projection base portion is disposed outside of the footpath and configured to support the box portion outside of the footpath with an access portion of the box portion configured to extend parallel to the footpath and facing the footpath so as to provide enhanced access to contents of the box portion from the footpath without obstructing the footpath with the box portion.

In some embodiments of the foregoing arrangements, the longitudinal wall portions and lateral wall portions of the main base portion and the longitudinal wall portion and the lateral wall portions of the projection base portion may comprise modular elements that are configured to be coupled with one another to form a continuous frame portion. In some embodiments, the frame portion may be configured to be stacked with another frame portion to form the base portion. In some embodiments, at least a portion of the frame portion may comprise plastic.

In some embodiments of the foregoing arrangements, an interior space of the main base portion may be open to an interior space of the protection base portion so as maximize a continuous interior space of the base portion and enhance a path for cabling to run from the base portion to the box portion.

In some embodiments of the foregoing arrangements, the access portion may be configured to provide access to the contents along a longitudinal surface portion of the box portion.

In some embodiments of the foregoing arrangements, the projection base portion may have a longitudinal dimension and a transverse dimension, and the longitudinal dimension of the projection base portion may be greater than the transverse dimension of the projection base portion, and the main base portion may have a longitudinal dimension and a transverse dimension, and the longitudinal dimension is greater than the transverse dimension.

In some aspects, the foregoing arrangement may further include a cover portion configured to cover a top portion of the main base portion.

In some embodiments of the foregoing arrangements, the main base portion and the projection base portion may each have a substantially rectangular cross-sectional area in a horizontal direction.

In some embodiments of the foregoing arrangements, the box portion may comprise a cabinet, and the access portion may comprise a door.

According to an exemplary embodiment of the disclosure, a street cabinet arrangement may include a box portion configured to house contents of a communications network therein and a base portion configured to be disposed underground and having a portion that is configured to support the box portion. The base portion may include a projection base portion configured to extend from the main base portion. At least a portion of the main base portion is configured to be disposed underground beneath a footpath with a longitudinal dimension of the main base portion and a longitudinal dimension of the projection base portion extending parallel to one another and to the footpath such that at least a portion of the projection base portion is disposed outside of the footpath and configured to support the box portion outside of the footpath with an access portion of the box portion configured to extend parallel to the footpath and facing the footpath so as to provide enhanced access to contents of the box portion from the footpath without obstructing the footpath with the box portion.

In some embodiments of the foregoing arrangements, the main base portion and the projection base portion may comprise modular elements that are configured to be coupled with one another to form a continuous frame portion In some embodiments, the frame portion may be configured to be stacked with another frame portion to form the base portion. In some embodiments, at least a portion of the frame portion may comprise plastic.

In some embodiments of the foregoing arrangements, an interior space of the main base portion may be open to an interior space of the protection base portion so as maximize a continuous interior space of the base portion and enhance a path for cabling to run from the base portion to the box portion.

In some embodiments of the foregoing arrangements, the access portion may be configured to provide access to the contents along a longitudinal surface portion of the box portion.

In some embodiments of the foregoing arrangements, the projection base portion may have a longitudinal dimension and a transverse dimension, and the longitudinal dimension of the projection base portion may be greater than the transverse dimension of the projection base portion, and the main base portion may have a longitudinal dimension and a transverse dimension, and the longitudinal dimension is greater than the transverse dimension.

In some aspects, the foregoing arrangement may further include a cover portion configured to cover a top portion of the main base portion.

In some embodiments of the foregoing arrangements, the main base portion and the projection base portion may each have a substantially rectangular cross-sectional area in a horizontal direction.

In some embodiments of the foregoing arrangements, the box portion may comprise a cabinet, and the access portion may comprise a door.

The foregoing and other features of construction and operation of the invention will be more readily understood and fully appreciated from the following detailed disclosure, taken in conjunction with accompanying drawings.

### BRIEF DESCRIPTION OF THE DRAWINGS

FIG. 1 is a perspective view of a box module arranged in the area of a shaft module, with the shaft module being closed by covers,

FIG. 2 is a perspective view of side walls of a shaft module with a projection extending outwards from the interior,

FIG. 3 is a perspective view of the device according to FIG. 2 with the frame attached in the area of the shaft module and in the area of the projection,

FIG. 4 is a perspective view of the arrangement according to FIG. 2 with a lower part of the cabinet module placed on the projection,

FIG. 5 is a perspective view of a frame of the shaft module with covers and support rails in an exploded view, and

FIG. 6 is a perspective view of the components according to FIG. 1 after installation in the area of a footpath.

### DETAILED DESCRIPTION OF EMBODIMENTS

As a preface to the detailed description, it should be noted that, as used in this specification and the appended claims, the singular forms “a,” “an,” and “the” include plural referents, unless the context clearly dictates otherwise.

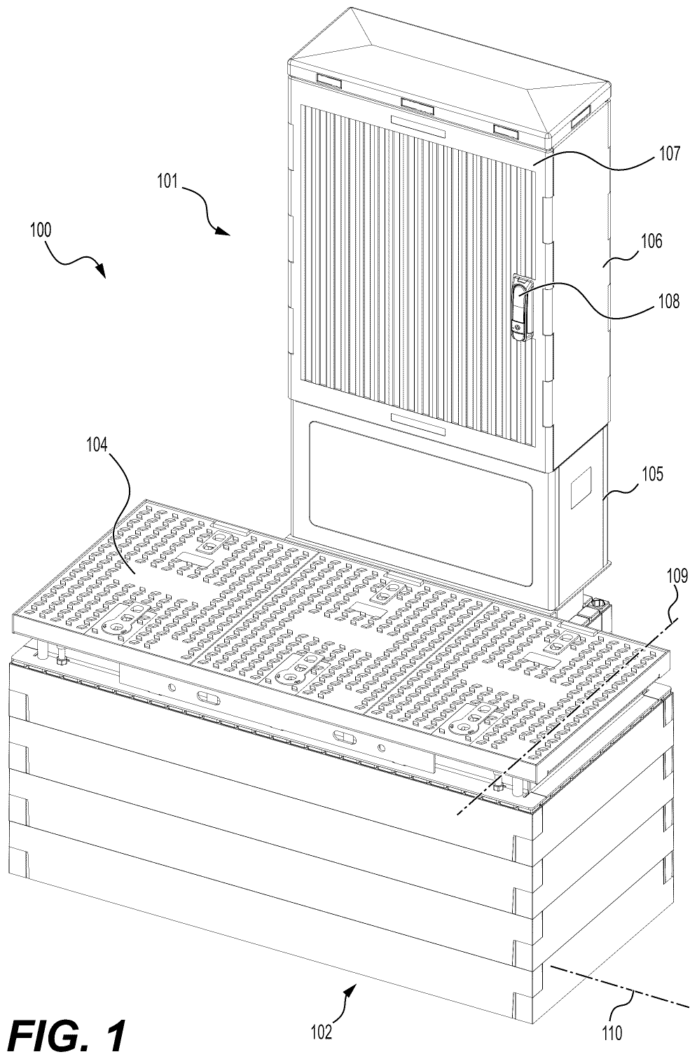

FIG. 1 shows a perspective representation of an arrangement 100 for storage and/or connection of cables and/or electronic components, for example, a street cabinet arrangement. The street cabinet arrangement 100 may include a box portion or cabinet portion 101, for example, a connection cabinet such as a fiber connection cabinet for passive optical networks, and a shaft portion or base portion 102, for example, a ground shaft or underground shaft. The cabinet portion may be arranged in an area of the shaft portion 102. The shaft portion 102 may be sunk into a footpath 103, for example. The street cabinet arrangement 100 may include a cover portion 104 to cover the shaft portion 102. In some embodiments, the cover portion 104 may include a plurality of covers 124 that are configured to be individually and separately coupled with the shaft portion 102.

According to the disclosure, the box portion 101 may comprise, for example, an outdoor housing that can be arranged above the ground, with or without the base portion 102. In some embodiments, the box portion 101 is configured to be suitable for outdoor applications. For example, the box portion 101 may be constructed with a tightness and/or resistance to the effects of moisture. In addition, in various embodiments, the box portion 101 may be a distributor portion and/or a cabinet portion and/or a housing portion.

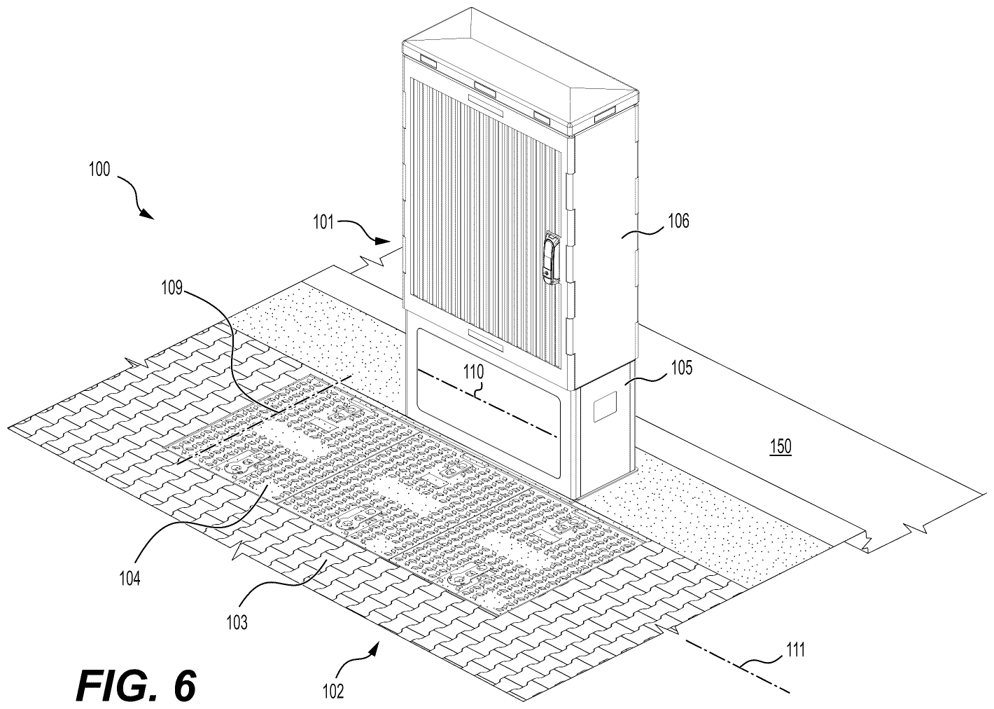

In the illustrated embodiment, the box portion 101 may include a first portion or lower portion 105 and a second portion or upper portion 106. As shown in FIGS. 1 and 6, the upper portion 106 is designed like a cabinet in the illustrated embodiment having, for example, a door portion 107 with a handle portion 108. In some embodiments, as an alternative to the door portion 108, the upper portion 106 may be provided with a flap or a removable wall element.

According to the exemplary embodiment in FIG. 1, the cover portion 104 may include the plurality of covers 124 arranged with the longitudinal axis 109 of each cover 124 extending in a direction transverse to a longitudinal axis 110 of the base portion 102. The longitudinal axis 110 of the base portion 102 typically runs parallel to a longitudinal axis 111 of the footpath 103, as shown in FIG. 6. The longitudinal axes 109 of the covers 124 thus also extend transversely to the longitudinal axis 111 of the footpath 103. A transverse stretch is typically understood to mean a course at an angle of approximately 90°.

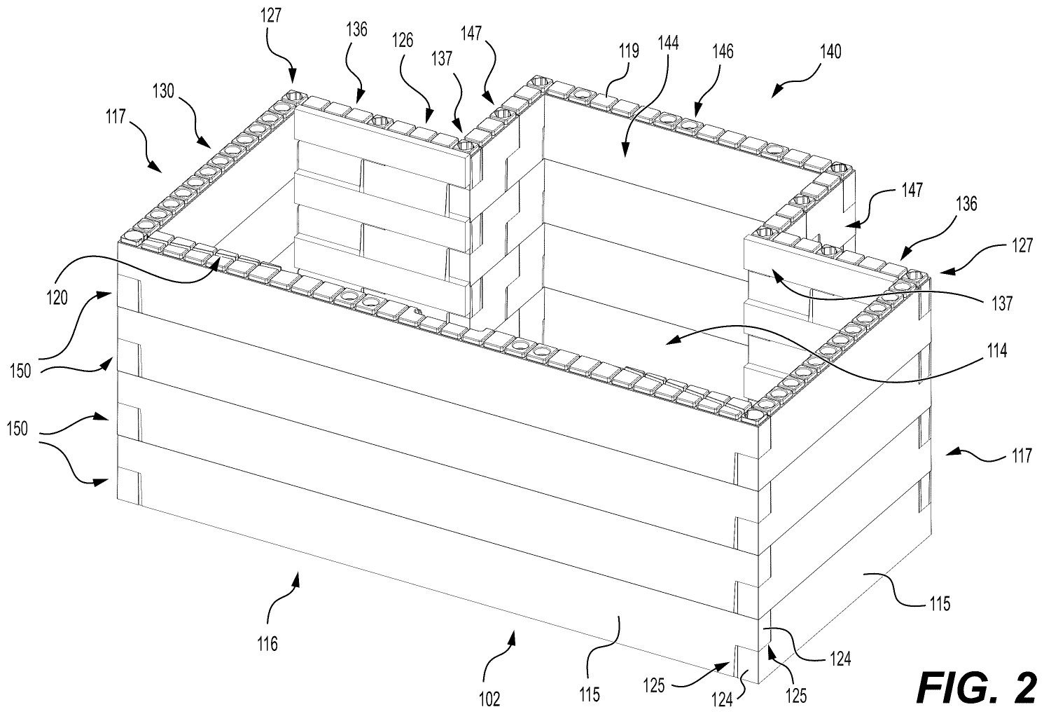

FIG. 2 shows the base portion 102 without the cover portion 104. The base portion 102 includes a first base portion or main base portion 130 and a second base portion or projection base portion 140. The main base portion 130 includes longitudinal wall portions 116, 126 and transverse wall portions 117 configured to delimit an interior space 114. The projection base portion 140 includes a longitudinal wall portion 146 and transverse wall portions 147. The projection base portion 140 extends from the longitudinal wall portion 126 in a direction away from the longitudinal wall portion 126.

In the illustrated exemplary embodiment, the longitudinal wall portion 126 includes two longitudinal wall segments 136 that extend from opposed corner portions 127 of the transverse wall portions 117. The transverse wall portions 147 extend from free ends 137 of the longitudinal wall segments 136. The longitudinal wall portion 146 of the projection box portion 140 extends from one of the transverse wall portions 147 to the other one of the transverse wall portions 147.

It can be seen in the exemplary embodiment illustrated in FIGS. 1-4 that projection base portion 140 is arranged in a middle area of a longitudinal side wall 112 of the main base portion 130. According to the exemplary embodiment shown in FIG. 2, the interior space 114 of the main base portion 130 is open to an interior space 144 of the projection base portion 140.

As shown, the base portion 102 may comprise modular elements 115. In the illustrated embodiment, there are each special modular elements for the longitudinal wall portion 116, the transverse wall portions 117, the longitudinal wall portion 126, and the projection base portion 113.

In the illustrated embodiment, the longitudinal wall portion 116, the transverse wall portions 117, the longitudinal wall portion 126, the longitudinal wall portion 146, and the transverse wall portions 147 may be configured to be coupled with one another to form a frame portion 150, and frame portions 150 can be positioned one above the other. The longitudinal wall portion 116, the transverse wall portions 117, and the longitudinal wall portion 126 of the main base portion 130 form a shape similar to a rectangle that encloses the interior 114. The longitudinal wall portion 146 and the transverse wall portions 147 of the projection base portion 140 also form a shape similar to a rectangle that encloses the interior space 144.

According to the embodiment in FIG. 2, the longitudinal wall portion 116, the transverse wall portions 117, the longitudinal wall portion 126, the longitudinal wall portion 146, and the transverse wall portions 147 may have engaging portions 124 and receiving portions 125 at their ends. The engaging portion 124 of one of the aforementioned wall portions 116, 117, 126, 146, 147 may be configured to engage in the receiving portion 125 of another one of the aforementioned wall portions 116, 117, 126, 146, 147.

As shown in the exemplary embodiment illustrated in FIG. 2, the modular elements that comprise the longitudinal wall portion 116, the transverse wall portions 117, and the longitudinal wall portion 146 may have a similar design, while the modular elements that comprise the longitudinal wall portion 126 and the transverse wall portions 147 may have a design that supports a change in the spatial extent of the projection base portion 140.

It can be seen from the illustration in FIG. 2 that the aforementioned wall portions 116, 117, 126, 146, 147 may include a coupling portion 119, for example, projections, that are arranged in an area of the upper surfaces of the aforementioned wall portions 116, 117, 126, 146, 147. The coupling portion 119 may correspond with a receiving portion, for example, depressions, in an area of the undersides of the aforementioned wall portions 116, 117, 126, 146, 147. The coupling portion 119 and the receiving portion together support the coupling of the aforementioned wall portions 116, 117, 126, 146, 147 with one another.

According to the embodiment in FIG. 2, a tensioning portion 120 may be arranged in a portion of the longitudinal wall portion 116. Pretensioning of the tensioning portion 120 may counteract external forces on the longitudinal wall portion 116 to prevent deformation of the longitudinal wall portion 116 toward the interior space 114.

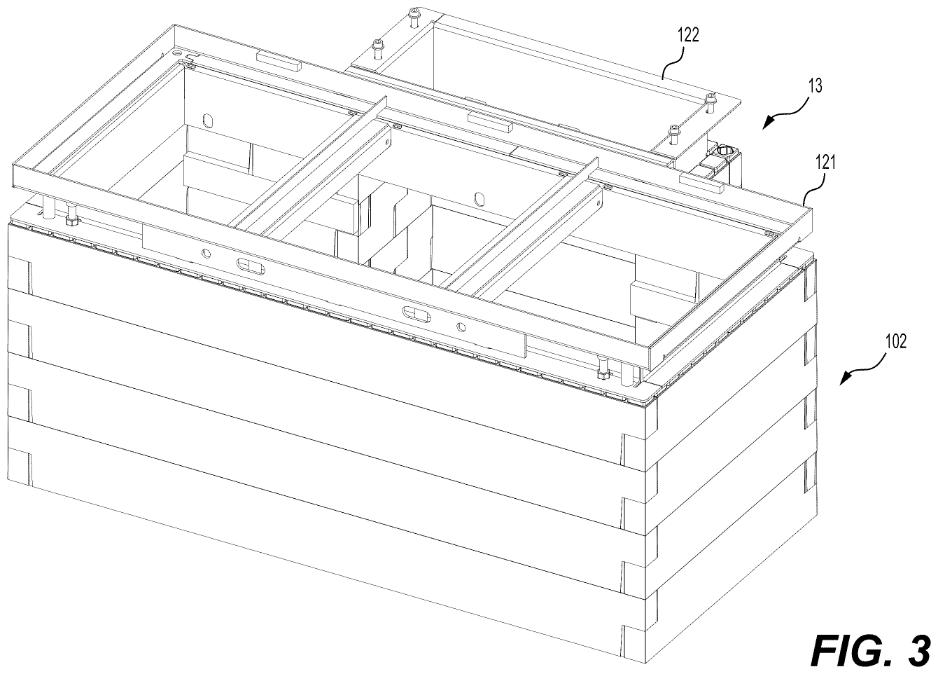

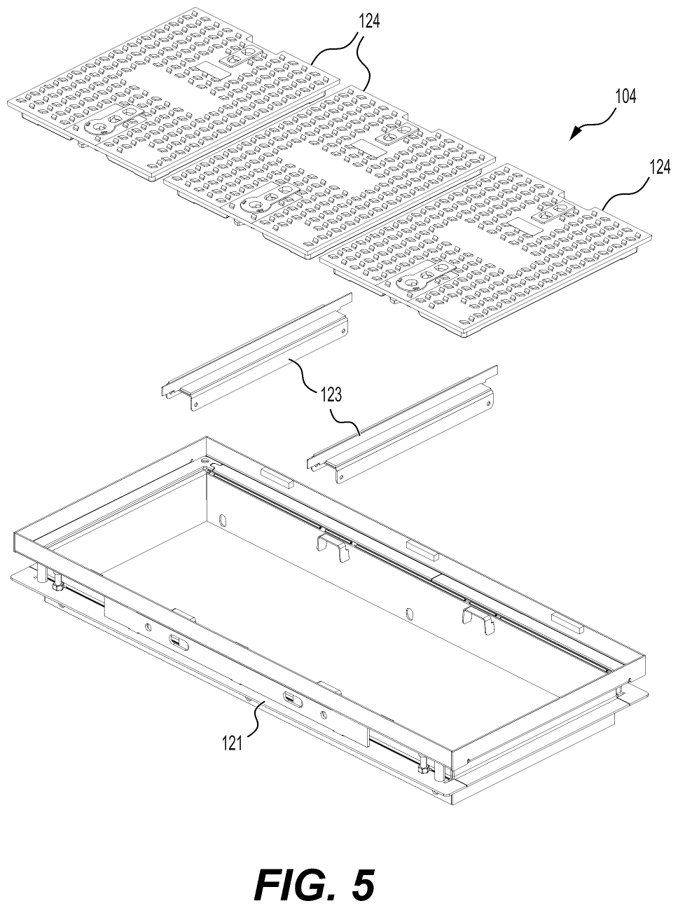

As best shown in FIG. 3, the street cabinet arrangement 100 may include a frame portion 121 configured to be attached with the base portion 102 at the main base portion 130. Referring again to FIG. 1, the cover portion 104 can be positioned in and/or on the frame portion 121. A projection frame portion 122 may be configured to be attached with the projection base portion 140 and to support the box portion 101. FIG. 5 illustrates a support portion 23, for example, support rails, that may be configured to be coupled with the frame portion 121 and to support the cover portion 104, as shown in the exemplary street cabinet arrangement of FIG. 1.

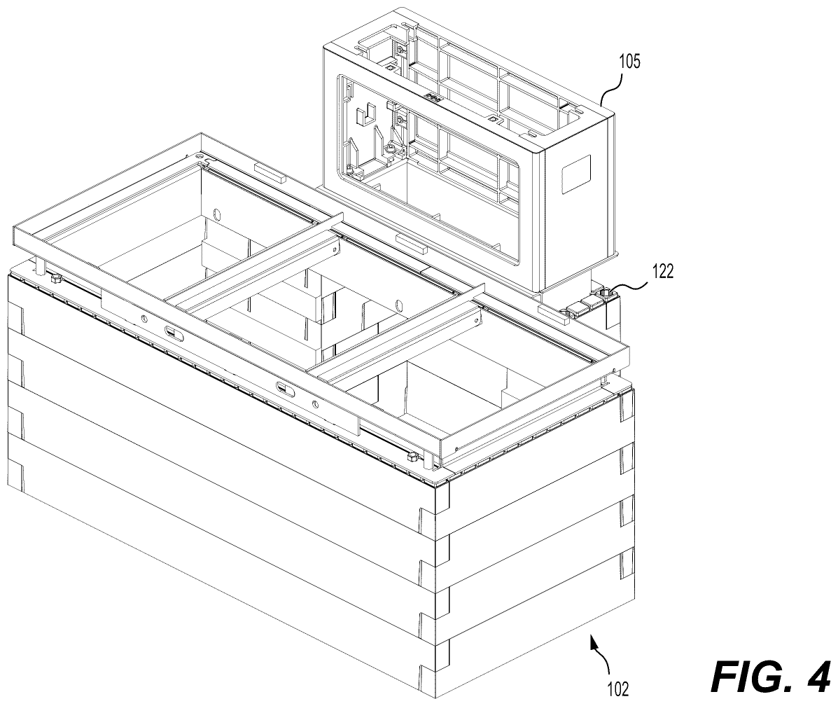

Referring now to FIG. 4, the projection frame portion 122 may be configured to support the lower portion 105 of the box portion 101 as the lower portion 105 is placed on the projection base portion 140.

Referring now to FIG. 6, the street cabinet arrangement 100 may be deployed in an area of the footpath 103. In the exemplary embodiment of FIG. 6, the main base portion 130 of the base portion 102 is disposed at the footpath 103, with the base portion 102 in the ground beneath the footpath 103 and the cover portion 104 at about ground level of the footpath 103, as would be understood by persons skilled in the art. In FIG. 6, the box portion 101, which includes the lower portion 105 and the upper portion 106, is depicted off the footpath 103 between the footpath 103 and a roadway 150. In order to support the box portion 101, the projection base portion 140 is also between the footpath 103 and the roadway 150. It should be understood that in some embodiments, the box portion 101 and the projection base portion 140 may be disposed at an opposite side of the footpath 103, for example, at a side of the footpath 103 opposite to the roadway 150. In some embodiments, the box portion 101 and the projection base portion 140 may be between the footpath 103 and a building or other structure (not shown).

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A street cabinet arrangement configured to disposed at a footpath and to provide enhanced access to an above ground portion of the street cabinet arrangement without obstructing the footpath, comprising:
a box portion configured to house contents of a communications network therein and having an access portion configured to provide access to the contents along a longitudinal surface portion of the box portion;
a base portion configured to be disposed underground and having a portion that is configured to support the box portion;
wherein the base portion includes a main base portion having spaced apart longitudinal wall portions connected with spaced apart lateral wall portions that extend in a transverse direction;
wherein the base portion includes a projection base portion configured to extend from a first one of the longitudinal wall portions of the main base portion;
wherein the projection base portion includes a longitudinal wall portion configured to extend parallel to the longitudinal wall portions of the main base portion and spaced apart lateral walls configured to extend in the transverse direction from the first one of the longitudinal wall portions of the main base portion to the longitudinal wall portion of the projection base portion;
wherein the longitudinal wall portions and lateral wall portions of the main base portion and the longitudinal wall portion and the lateral wall portions of the projection base portion comprise modular elements that are configured to be coupled with one another to form a continuous frame portion;
wherein the frame portion is configured to be stacked with another frame portion to form the base portion;
wherein the main base portion has a longitudinal dimension and a transverse dimension, and the longitudinal dimension is greater than the transverse dimension;
wherein the projection base portion has a longitudinal dimension and a transverse dimension, and the longitudinal dimension of the projection base portion is greater than the transverse dimension of the projection base portion;
wherein an interior space of the main base portion is open to an interior space of the protection base portion so as maximize a continuous interior space of the base portion and enhance a path for cabling to run from the base portion to the box portion; and
wherein at least a portion of the main base portion is configured to be disposed underground beneath a footpath with the longitudinal dimension of the main base portion and the longitudinal dimension of the projection base portion extending parallel to one another and to the footpath such that at least a portion of the projection base portion is disposed outside of the footpath and configured to support the box portion outside of the footpath with the longitudinal surface portion of the box portion configured to extend parallel to the footpath and the access portion facing the footpath so as to provide enhanced access to contents of the box portion from the footpath without obstructing the footpath with the box portion.

2. The arrangement of claim 1, further comprising a cover portion configured to cover a top portion of the main base portion.

3. The arrangement of claim 1, wherein the main base portion and the projection base portion each have a substantially rectangular cross-sectional area in a horizontal direction.

4. The arrangement of claim 1, wherein at least a portion of the frame portion comprises plastic.

5. The arrangement of claim 1, wherein the box portion comprises a cabinet, and the access portion comprises a door.

6. A street cabinet arrangement configured to disposed at a footpath and to provide enhanced access to an above ground portion of the street cabinet arrangement without obstructing the footpath, comprising:
a box portion configured to house contents of a communications network therein;
a base portion configured to be disposed underground and having a portion that is configured to support the box portion;
wherein the base portion includes a main base portion having spaced apart longitudinal wall portions connected with spaced apart lateral wall portions that extend in a transverse direction;
wherein the base portion includes a projection base portion configured to extend from a first one of the longitudinal wall portions of the main base portion;
wherein the projection base portion includes a longitudinal wall portion configured to extend parallel to the longitudinal wall portions of the main base portion and spaced apart lateral walls configured to extend in the transverse direction from the first one of the longitudinal wall portions of the main base portion to the longitudinal wall portion of the projection base portion;
wherein at least a portion of the main base portion is configured to be disposed underground beneath a footpath with a longitudinal dimension of the main base portion and a longitudinal dimension of the projection base portion extending parallel to one another and to the footpath such that at least a portion of the projection base portion is disposed outside of the footpath and configured to support the box portion outside of the footpath with an access portion of the box portion configured to extend parallel to the footpath and facing the footpath so as to provide enhanced access to contents of the box portion from the footpath without obstructing the footpath with the box portion.

7. The arrangement of claim 6, wherein the longitudinal wall portions and lateral wall portions of the main base portion and the longitudinal wall portion and the lateral wall portions of the projection base portion comprise modular elements that are configured to be coupled with one another to form a continuous frame portion.

8. The arrangement of claim 7, wherein the frame portion is configured to be stacked with another frame portion to form the base portion.

9. The arrangement of claim 7, wherein at least a portion of the frame portion comprises plastic.

10. The arrangement of claim 6, wherein an interior space of the main base portion is open to an interior space of the protection base portion so as maximize a continuous interior space of the base portion and enhance a path for cabling to run from the base portion to the box portion.

11. The arrangement of claim 6, wherein the access portion is configured to provide access to the contents along a longitudinal surface portion of the box portion.

12. The arrangement of claim 6, further comprising a cover portion configured to cover a top portion of the main base portion.

13. The arrangement of claim 6, wherein the main base portion and the projection base portion each have a substantially rectangular cross-sectional area in a horizontal direction.

14. The arrangement of claim 6, wherein the projection base portion has a longitudinal dimension and a transverse dimension, and the longitudinal dimension of the projection base portion is greater than the transverse dimension of the projection base portion, and
wherein the main base portion has a longitudinal dimension and a transverse dimension, and the longitudinal dimension is greater than the transverse dimension.

15. The arrangement of claim 6, wherein the box portion comprises a cabinet, and the access portion comprises a door.

16. A street cabinet arrangement configured to disposed at a footpath and to provide enhanced access to an above ground portion of the street cabinet arrangement without obstructing the footpath, comprising:
a box portion configured to house contents of a communications network therein;
a base portion configured to be disposed underground and having a portion that is configured to support the box portion;
wherein the base portion includes a projection base portion configured to extend from the main base portion;
wherein at least a portion of the main base portion is configured to be disposed underground beneath a footpath with a longitudinal dimension of the main base portion and a longitudinal dimension of the projection base portion extending parallel to one another and to the footpath such that at least a portion of the projection base portion is disposed outside of the footpath and configured to support the box portion outside of the footpath with an access portion of the box portion configured to extend parallel to the footpath and facing the footpath so as to provide enhanced access to contents of the box portion from the footpath without obstructing the footpath with the box portion.

17. The arrangement of claim 16, wherein the main base portion and the projection base portion comprise modular elements that are configured to be coupled with one another to form a continuous frame portion.

18. The arrangement of claim 17, wherein the frame portion is configured to be stacked with another frame portion to form the base portion.

19. The arrangement of claim 17, wherein at least a portion of the frame portion comprises plastic.

20. The arrangement of claim 16, wherein an interior space of the main base portion is open to an interior space of the protection base portion so as maximize a continuous interior space of the base portion and enhance a path for cabling to run from the base portion to the box portion.

21. The arrangement of claim 16, wherein the access portion is configured to provide access to the contents along a longitudinal surface portion of the box portion.

22. The arrangement of claim 16, further comprising a cover portion configured to cover a top portion of the main base portion.

23. The arrangement of claim 16, wherein the main base portion and the projection base portion each have a substantially rectangular cross-sectional area in a horizontal direction.

24. The arrangement of claim 16, wherein the projection base portion has a longitudinal dimension and a transverse dimension, and the longitudinal dimension of the projection base portion is greater than the transverse dimension of the projection base portion, and
wherein the main base portion has a longitudinal dimension and a transverse dimension, and the longitudinal dimension is greater than the transverse dimension.

25. The arrangement of claim 16, wherein the box portion comprises a cabinet, and the access portion comprises a door.
